(19) United States
(12) Patent Application Publication
(10) Pub. No.: US 2007/0178236 A1
(43) Pub. Date: Aug. 2, 2007

(54) Method and apparatus for anti-corrosive coating

(76) Inventors: N. Tim Larsen, Tampa, FL (US); Dale Wolf, Eugene, OR (US)

Correspondence Address: KOLISCH HARTWELL, P.C., 200 PACIFIC BUILDING, 520 SW YAMHILL STREET, PORTLAND, OR, 97204, US

(21) Appl. No.: 10/326,610

(22) Filed: Dec. 20, 2002

Related U.S. Application Data
(60) Provisional application No. 60/343,462, filed on Dec. 20, 2001.

(51) Int. Cl. B05D 3/02; B05D 3/00; B05D 1/36

(52) U.S. Cl. 427/314; 427/398.3; 427/402

(57) ABSTRACT

A method of applying an anti-corrosive coating to a work piece includes the steps of providing a work piece, cleaning and surfacing, and heating it. The method also includes coating the work piece with anti-corrosive material, and then coating the anti-corrosive-coated work piece with a protective coating. The method also includes quenching the twice-coated work piece.

### CROSS-REFERENCE TO RELATED APPLICATIONS

This application claims priority to U.S. Provisional Patent Application Ser. No. 60/343,462, filed Dec. 20, 2001 and entitled “Method and Apparatus for Anti-Corrosive Coating”.

### BACKGROUND OF THE INVENTION

The present invention relates generally to the application of anti-corrosive coatings, and more particularly, to application of anti-corrosive coatings to metal surfaces.

### SUMMARY OF THE INVENTION

Method and apparatus for applying an anti-corrosive coating to a metal surface are provided.

### BRIEF DESCRIPTION OF THE DRAWINGS

FIG. 1 is a flow chart illustrating an anti-corrosive coating process according to an embodiment of the present invention;

FIG. 2 is a flow chart illustrating an anti-corrosive process according to a second embodiment of the present invention;

FIG. 3 is a photograph showing a section of “black bar” rebar as it may be received from a steel manufacturing facility;

FIG. 4 is a photograph showing a section of rebar, such as shown in FIG. 1, after a wheel ablation process in accordance with an embodiment of the invention;

FIG. 5 is a photograph showing a section of rebar, as shown in FIGS. 1 and 2, after a sputter coating process in accordance with an embodiment of the invention;

FIG. 6 is a photograph showing a section of rebar, as shown in FIGS. 1, 2 and 3, after a thermal epoxy application process in accordance with an embodiment of the invention;

FIG. 7 is a photograph showing the rebar sections shown in FIGS. 3-6 to illustrate the differences in surface appearance at various stages of anti-corrosive coating processes according to embodiments of the invention;

FIG. 8 is a photograph showing the front end a coating manufacturing line according to an embodiment of the invention;

FIG. 9 is a photograph showing the interior of a wheel ablation chamber included in the manufacturing line of FIG. 8;

FIG. 10 is a photograph showing a metal sputter gun included in the manufacturing line of FIG. 8;

FIG. 11 is a photograph showing an epoxy coating chamber and a gel section included in the manufacturing line of FIG. 8;

FIG. 12 is a photograph showing a cure section of the manufacturing line of FIG. 8.

### DETAILED DESCRIPTION OF THE PREFERRED EMBODIMENT

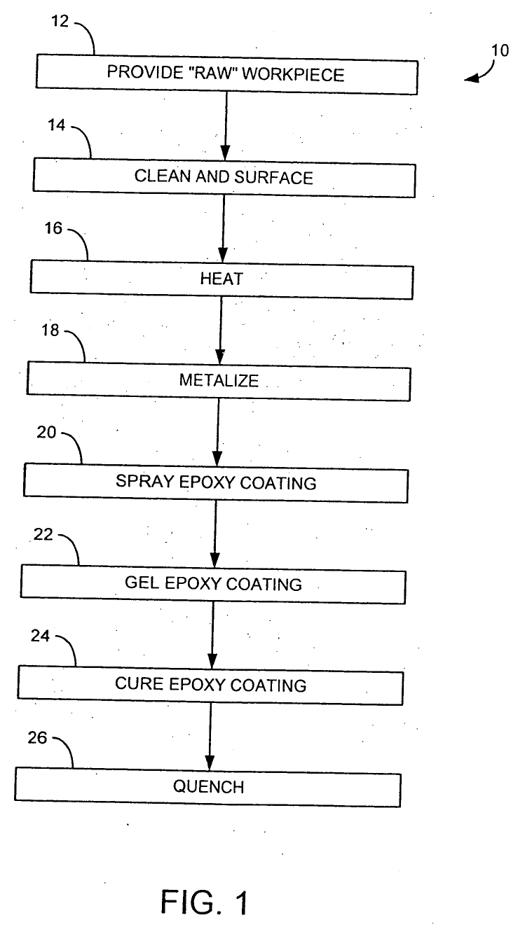

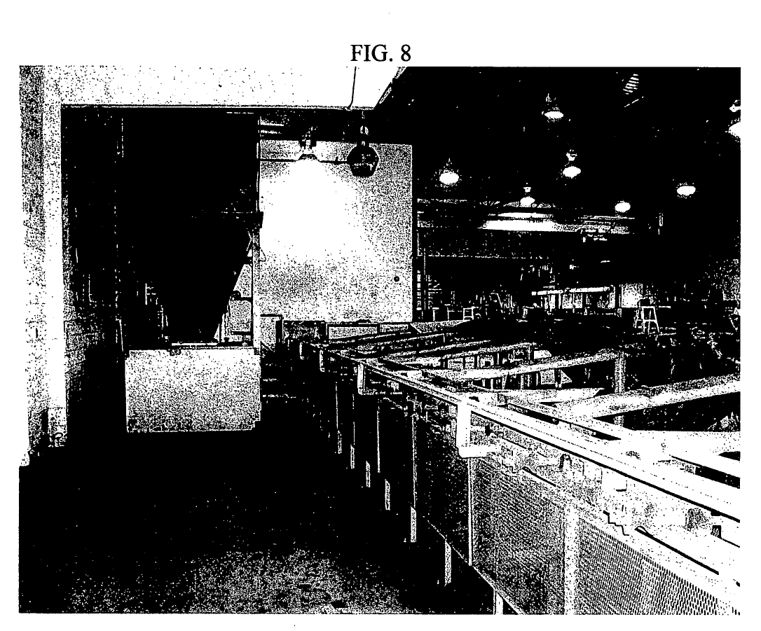

Referring to FIG. 1, a flowchart illustrating a method of applying an anti-corrosive coating according to an embodiment of the present invention is shown generally at 10. At 12, a “raw” metal work piece is provided. Such a metal piece may be an object formed from metal that may be susceptible to corrosion, such as steel. In one embodiment, a section of steel rebar may be loaded on a coating manufacturing line via rollers, such as the manufacturing line depicted in FIG. 8. While the embodiments of the invention described herein are generally directed to an anti-corrosive coating process for steel rebar, the invention may be applied to coat numerous other types of metal objects, such as structural beams, steel bridge components or motor vehicle frames, as some examples.

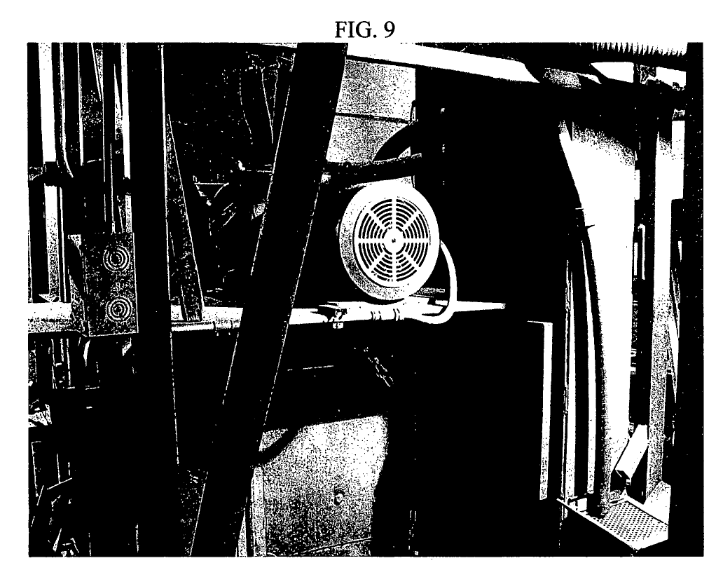

At 14, the metal object to be coated is cleaned and surfaced. In this regard, preparing steel rebar with a “near white” finish, such as is described in the Painter's Council Handbook, or the specifications known as “Visual Reference SP10” or “SS Visual 1” in the Steel Structures Painting Council (SSPC), may be desired. One technique for accomplishing such surface preparation is by wheel ablation. Wheel ablation may be accomplished by employing a wheel that includes plural vanes, or blades. The wheel may be rotated at a high rate of speed and sand, or other abrasive material (“sand”), introduced into the rotating wheel. The sand may then be expelled from the wheel at a high rate of speed and impinge on the metal object. In this regard, the object being treated may be rotated, or otherwise manipulated, and drawn through the path of the impinging sand to achieve a substantially consistent surface topology. In this regard, a standard anchor profile, which is known, may be achieved when repairing the surface of steel rebar with wheel ablation. The interior of a chamber for accomplishing such wheel ablation is depicted in FIG. 9. Of course, other techniques may be employed, and the invention is not limited to the use of wheel ablation. For example, conventional sandblasting techniques may be employed, as one alternative. Such surface preparation may remove any corrosion on the surface of the metal object and also provide a surface that improves adhesion of subsequent materials applied to the object, as is discussed below.

At 16, the object may be heated. Such heating may be accomplished using a furnace, oven or heat induction coil. Such heating may further improve the adhesion of materials applied in subsequent operations of the process. The temperature to which the bar is heated will depend on the specific embodiment and materials used. Typically temperatures for embodiments in accordance with the invention may range from 430-550° F., though the invention is not limited in this respect. As indicated above, the specific temperature may depend on the particular materials used to coat the metal object, such as metalization alloy and epoxy powder, for example.

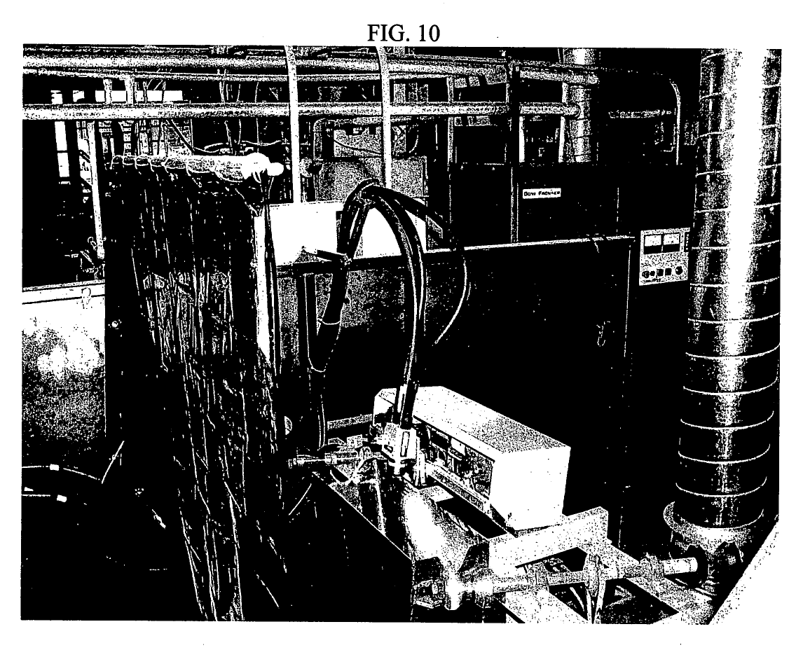

At 18 in FIG. 1, a metal object being coated may be metalized, or coated with an anti-corrosive metal alloy. Various techniques for performing such coating are possible. For example, an arc spray system may be employed. Such a system that may be used is the Model BP400 Arc Spray System depicted in FIG. 10, available from Praxair Surface Technologies, Inc., Thermal Spray Products, N670 Communication Drive, Appleton, Wis. 54915. A data sheet for this spray system is attached herewith as Exhibit A.

Employing such a spray system, an alloy may be sprayed over the surface of the metal object being coated. Typically, a gun of such a spray systems would, during operation, be slid back and forth in a parallel path to the metal object being coated. This motion of the gun may improve uniformity of the alloy coating, which is desired. In such a system, wire is typically employed as the alloy source. Compositions for such wires may vary. For example, wire composed of ninety-eight percent zinc and two percent aluminum may be used. Alternatively, an eighty-five percent zinc and fifteen percent aluminum wire maybe used. In other embodiments, a pseudo-alloy spray may be applied. In such applications a pure zinc wire and a pure aluminum wire may be employed, with the amount of each wire consumed during application to an object controlled to achieve a desired alloy ratio. An electrical arc typically vaporizes wire in such a system. This vapor is then sprayed on the surface of the metal object being coated. Of course the invention is not limited to the particular alloys or techniques discussed above, and other equipment, material, or approaches may be employed.

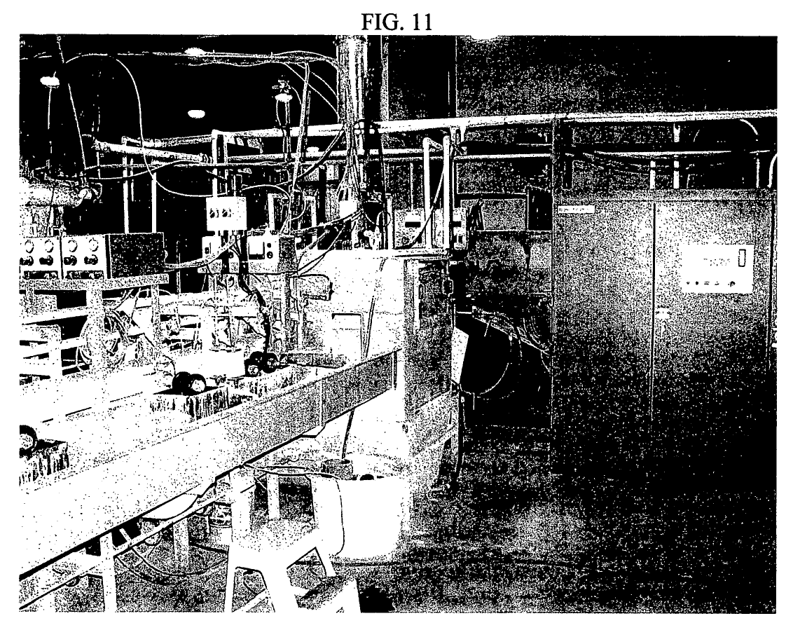

At 20 in FIG. 1, an epoxy powder may be sprayed onto the heated, metalized object being coated in a chamber such as that depicted in FIG. 11. Epoxy powders suitable for such an application are available. For example NAP-GARD® 7-2719 is available from DuPont Powder Coatings, 9800 Genard, Houston, Tex. 77041. A data sheet for this powder is attached herewith as Exhibit B. Such a powder is typically applied dry, and melts upon contact with the heated metal object, such as steel rebar. Epoxy powder may be sourced for such application from a vat, where pumping dry air through the powder may fluidize it to facilitate spraying. Additionally, an electrostatic charge may be introduced into the epoxy powder to improve attraction of the powder with an object being coated, such as grounded steel rebar.

At 22, the melted epoxy may gel. Because rollers may be employed for such coating processes, such as for coating steel rebar, a gel time is typically employed to allow a thermal-setting epoxy to harden, in order to prevent damage from the first roller encountered after the epoxy is applied. Gel times may vary depending on the particular epoxy employed, and on the ambient environment conditions. In this regard, gel times may be in the range of three to twelve seconds, though the invention is not so limited and longer or shorter gel times may be possible. However, shorter gel times are typically desirable to allow for increased manufacturing line speed.

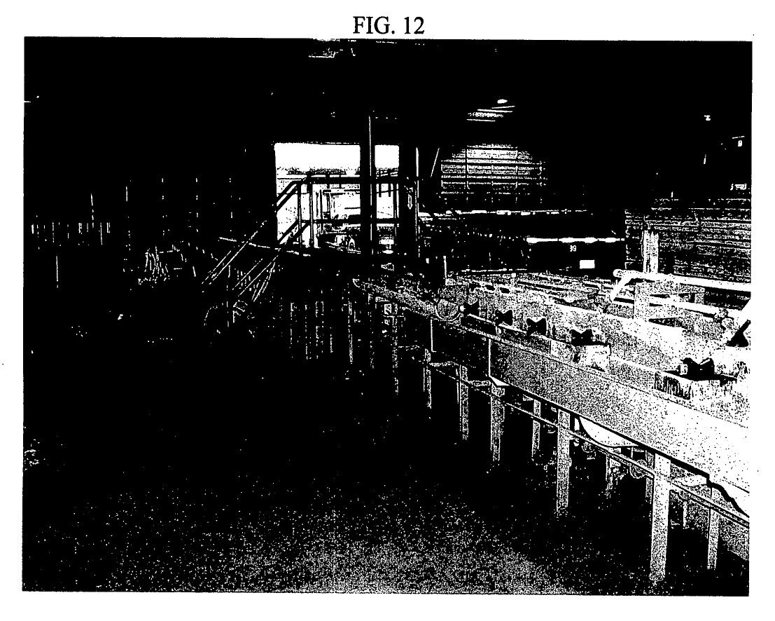

At 24, the epoxy coating is cured. For steel rebar coating processes, wet canted rollers may be used to prevent damage to the coating and to rotate the rebar for facilitating earlier coating operations on the object being coated. Such rollers are depicted in FIG. 12. Cure time is the time employed to complete the thermosetting of the epoxy coating. While the cure time depends on the particular embodiment, cure times typically range from twenty to thirty-five seconds.

At 26, the object, such as rebar, may be quenched. Quenching may be accomplished by passing the coated rebar through a series of low-pressure water streams. Quenching reduces the temperature of the rebar and further hardens the epoxy coating to prevent damage from handling after the completion of the coating process. It is noted that quenching and curing are distinct operations and applying a water stream prior to the completion of the epoxy cure may result in damage to the coating.

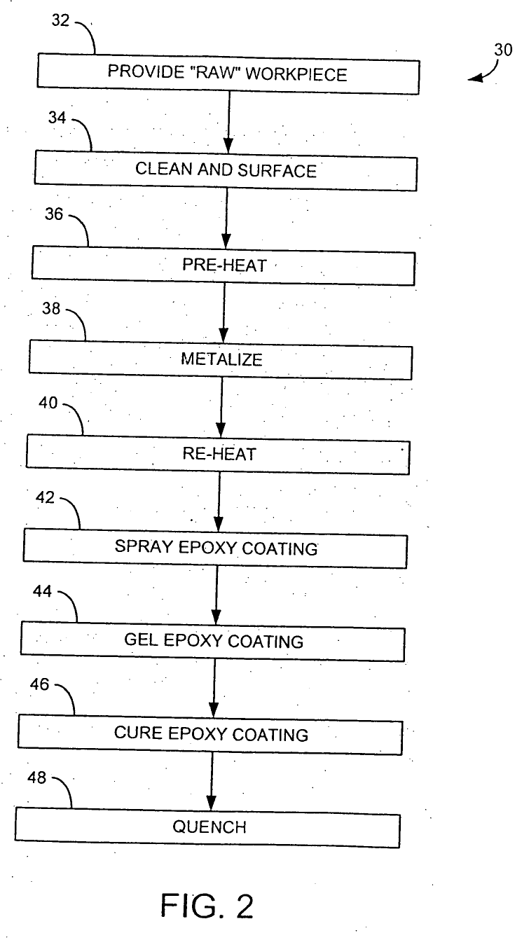

An alternative method for applying an anti-corrosive coating is shown in FIG. 2 and indicated generally at 30. Method 30 is similar to method 10 and, therefore, only the differences in the two processes will be discussed below. For method 30, heating of the object being coated is done in two operations, 36 and 38, rather than one operation as was the case with method 10. In this respect, an object to be coated may be pre-heated at 36. The temperature of pre-heat at 36 would typically be a lower temperature than indicated above for heating at 16. For example, an object may be pre-heated to ˜300° F. at 36. This lower temperature may be employed to improve adhesion of the metalization applied at 38 for certain alloy compositions. An object being coated may then be reheated to a temperature appropriate for applying epoxy coating at 42. These temperatures may be in the range of those discussed above with respect to method 10.

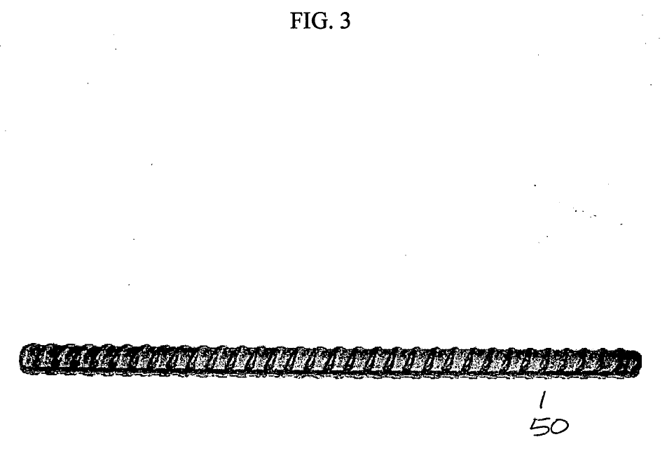

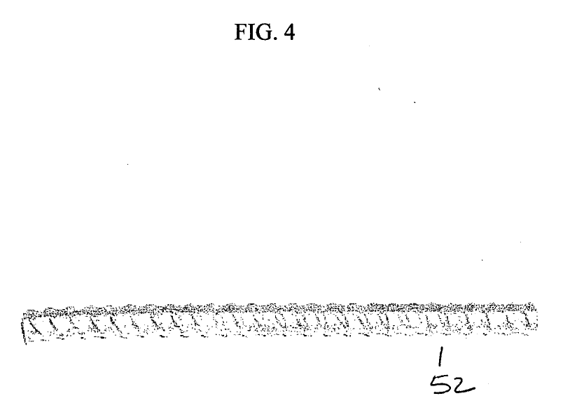

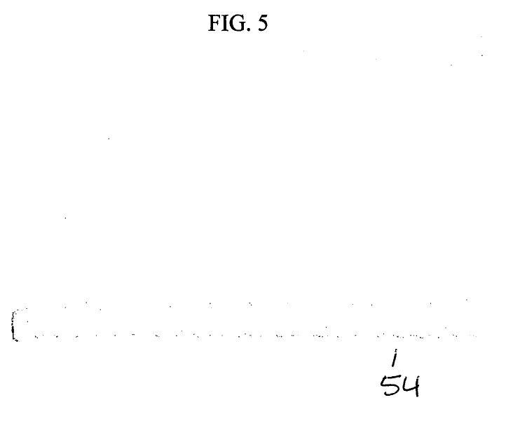

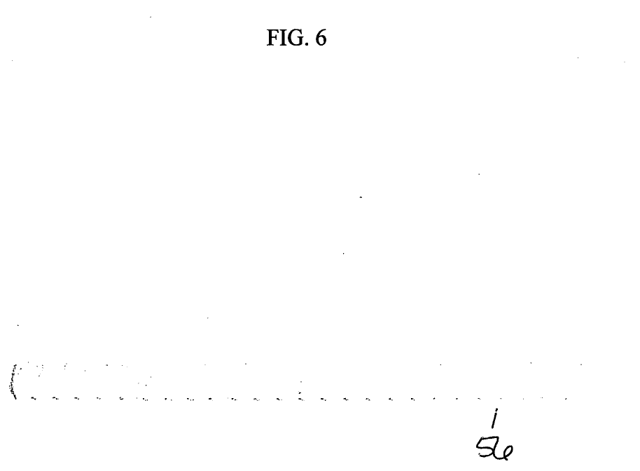

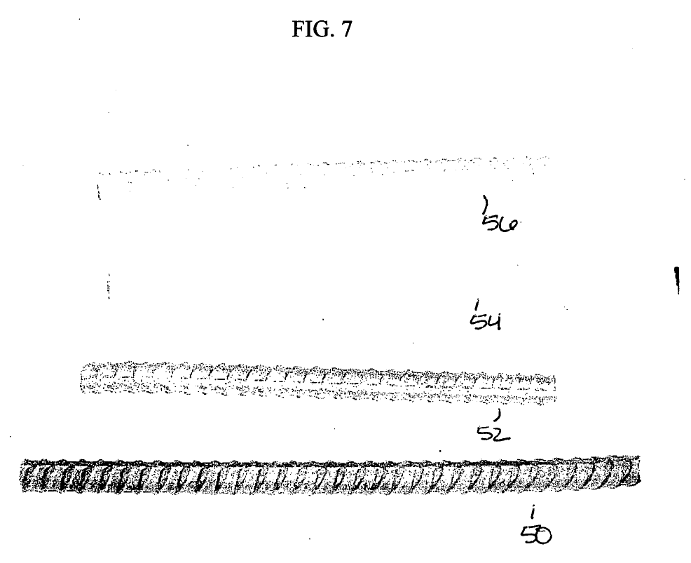

FIG. 3-7 show sections of rebar at various points in a coating process such as those just discussed. In this regard, FIG. 3 shows a section of “raw” or “black” rebar 50. Rebar 50 appears as it may be received from a steel manufacturer, prior to any processing. FIG. 4 shows a section of rebar 52 after cleaning and surface preparation, such as may be done with wheel ablation. FIG. 5 shows a section of rebar 54 after metalization with a zinc-aluminum alloy using an arc spray system, as previously discussed. FIG. 6 shows a section of rebar 56 after epoxy powder application, gel, cure and quench. Rebar 56 appears as it may be shipped to a customer for use in various structural or construction applications. FIG. 7 shows rebar sections 50, 52, 54 and 56 side by side to illustrate the different surface characteristics and appearance at the various process operations, relative to one another.

While the invention has been disclosed in its preferred form, the specific embodiments thereof as disclosed and illustrated herein are not to be considered in a limiting sense, because numerous variations are possible. The subject matter of the invention includes all novel and non-obvious combinations and sub-combinations of the various components, features, functions, and/or properties disclosed herein. No single feature, function, element, or property of the disclosed embodiments is essential.

We claim:

1. A method of applying an anti-corrosive coating to a work piece, comprising the steps of:
providing a work piece;
cleaning and surfacing the work piece;
heating the work piece;
coating the work piece with anti-corrosive material;
coating the anti-corrosive-coated work piece with a protective coating; and
quenching the twice-coated work piece.
